(19) United States
(12) Patent Application Publication
(10) Pub. No.: US 2006/0130330 A1
(43) Pub. Date: Jun. 22, 2006

(54) Electroconductive toner supply roller, method of preparing a supply roller, and electrophotographic imaging apparatus

(75) Inventor: Tae-hyun Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/213,909

(22) Filed: Aug. 30, 2005

(30) Foreign Application Priority Data
Dec. 18, 2004 (KR) 10-2004-0108399

(51) Int. Cl. B21D 53/00; G03G 15/02

(52) U.S. Cl. 29/895.21; 29/895.3; 399/176

(57) ABSTRACT

An electroconductive toner supply roller, a method of preparing the supply roller, and an electrophotographic imaging apparatus including the electroconductive toner supply roller are provided. More particularly, an electroconductive toner supply roller including a reactive conducting agent so as to prevent the formation of a sticky foam and migration of an ionic conducting agent. The electroconductive toner supply roller avoids the formation of a foam resulting from an increase of viscosity due to the addition of an electroconductor. An electrophotographic imaging apparatus is produced comprising the electroconductive toner supply roller.

### BACKGROUND OF THE INVENTION

This application claims priority to Korean Patent Application No. 10-2004-0108399, filed on Dec. 18, 2004, in the Korean Intellectual Property Office, the disclosure of which is incorporated herein by reference in its entirety.

1. Field of the Invention

The present invention relates to an electroconductive toner supply roller, a method of preparing the supply roller, and an electrophotographic imaging apparatus including the electroconductive toner supply roller. More particularly, the present invention relates to an electroconductive toner supply roller having a reactive conducting agent so as to prevent the formation of a sticky foam and migration of an ionic conductor. The invention prevents the formation of a foam resulting from an increase in the viscosity of the liquid toner caused by the addition of an electronic conducting agent. The invention is also directed to a method of preparing the supply roller, and to an electrophotographic imaging apparatus comprising the electroconductive toner supply roller.

2. Description of the Related Art

FIG. 1 is a schematic view of a conventional electrophotographic imaging apparatus which operates as described below. A photoreceptor 11 is charged by a charging unit 16, and then an electrostatic latent image is formed on the photoreceptor 11 by exposing an image to light through a laser scanning unit (LSU) 18. A toner 14 is supplied to a developing roller 12 by a toner supply roller 13. The toner 14 supplied to the developing roller 12 is laminated to a uniform thickness by a toner layer regulator 15 and is simultaneously charged by vigorous friction. Then, the laminated toner is developed into the electrostatic latent image formed on the photoreceptor 11, and then the developed toner is transferred to a sheet of paper by a transfer roller 19 and fixed to a fixing unit (not shown). A cleaning blade 17 cleans any residual toner 14 that remains after the transferring of the photoreceptor image.

In the electrophotographic imaging apparatus as described above, the toner supply roller 13 provides a uniform predetermined charge quantity q/m to the toner 14 by the interaction with the developing roller or the toner layer regulator. The apparatus supplies the toner to the developing roller and resets a non-developed toner, which are essential to the developing device. Conventionally, the toner supply roller is composed of a polyurethane foam or a silicone foam. The polyurethane foam is cheaper and has lower hardness than the silicone foam. Thus, the polyurethane foam is used to relieve toner stress in a high speed roller or a roller used for a long period of time.

To provide the polyurethane foam with electroconductivity, an ionic conducting agent or an electronic conducting agent is typically added to the polyurethane foam.

Examples of the ionic conducting agent include perchlorate, chlorate, hydrochloride, bromate, oxoate, hydrofluoroborate, sulfate, ethyl sulfate, carbonate, and sulfonate of tetraethylammonium, tetrabutylammonium, lauryltrimethylammonium, decyltrimethylammonium, octadecyltrimethylammonium, stearyltrimethylammonium, benzyltrimethylammonium, dimethylethylammonium, and the like. Other ionic conducting agents include perchlorate, chlorate, hydrochloride, bromate, oxoate, hydrofluoroborate, sulfate, ethyl sulfate, carbonate, and sulfonates of alkali metals or alkali earth metals such as Li, Na, K, Ca, Mg, and the like.

Examples of the electronic conducting agent include: electroconductive carbon black such as ketzen black and acetylene black; carbon for ink treated with an oxidizing agent, pyrolytic carbon, natural graphite, artificial graphite; metal oxides such as tin oxide, titanium oxide, zinc oxide, and the like; and metals such as Ag, Ni, Cu, Ge, and the like.

However, when the ionic conducting agent is used in an excessive amount (generally 5 phr or more), a foam is formed which becomes sticky and is broken down. Thus, the ionic conducting agent should be used in a small amount, which does not provide the foam with low or average resistance. When the electroconductive carbon black having a small particle size and a large structure is used as the electronic conducting agent, carbon black particles increases the viscosity of a polyol solution. As a result, it is difficult to form a foam through a reaction of polyol with isocyanate and obtain uniform cells.

### SUMMARY OF THE INVENTION

The present invention provides an electroconductive toner supply roller which can solve the problems often caused by the use of the ionic conducting agent, such as the formation of a sticky foam and breakdown of a foam. The electroconductive supply roller also overcomes the difficulties of the formation of a foam and uniform cells caused by the electronic conducting agent. The electroconductive toner supply roller has a low hardness to reduce toner stress and can be prepared at low cost. The invention is also directed to a method of preparing the electroconductive supply roller and to an electrophotographic imaging apparatus comprising the electroconductive toner supply roller.

According to an aspect of the present invention, an electroconductive toner supply roller is provided which includes a polyurethane foam member and a core bar, wherein an electroconductive carbon black, a binder resin and a charge controlling agent (CCA) are impregnated into or attached to the polyurethane foam.

According to another aspect of the present invention, a method of preparing an electroconductive toner supply roller is provided which includes: preparing a polyurethane foam member by adding additives including a catalyst, a blowing agent and an antifoaming agent to a compound having at least two active hydrogens and a compound having at least two isocyanate groups, stirring and mixing the resulting mixture to expand and cure; impregnating the polyurethane foam with an impregnation solution containing an electroconductive carbon black, a binder resin and a charge controlling agent to attach the electroconductive carbon black, the binder resin and the charge controlling agent to a cell wall of the polyurethane foam; drying the polyurethane foam; inserting a core bar into the polyurethane foam and adhering the polyurethane foam to the core bar; and polishing an outer surface of the polyurethane foam.

According to another aspect of the present invention, an electrophotographic imaging apparatus is provided which includes the electroconductive toner supply roller.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram of a conventional electrophotographic imaging apparatus; and

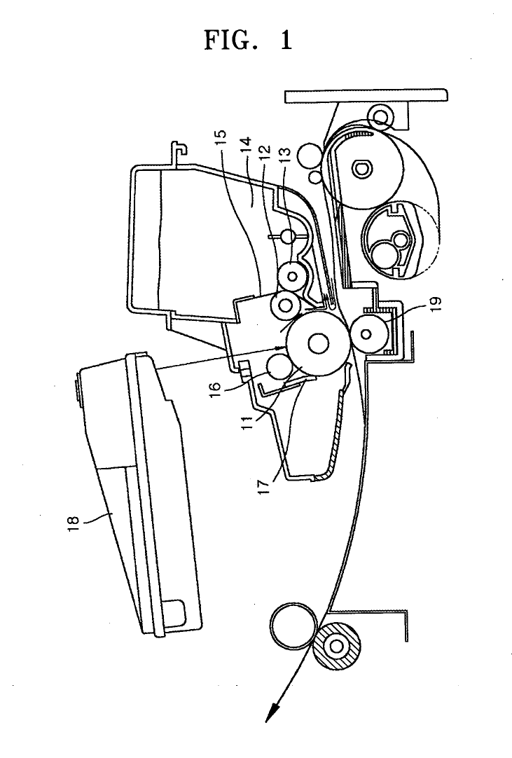

FIG. 2 is a schematic perspective view of an electroconductive toner supply roller according to an embodiment of the present invention.

### DETAILED DESCRIPTION OF THE INVENTION

Hereinafter, the present invention will be described in more detail.

The present invention provides an electroconductive toner supply roller, a method of preparing the electroconductive toner supply roller and an electrophotographic imaging apparatus including the electroconductive toner supply roller. According to the present invention, an electroconductive toner supply roller provides good charge properties to a toner, and has a low production cost and a low hardness.

An electroconductive toner supply roller according to an embodiment of the present invention includes a polyurethane foam and a core bar, wherein an electroconductive carbon black, a binder resin and a charge controlling agent (CCA) are impregnated into or attached to the polyurethane foam.

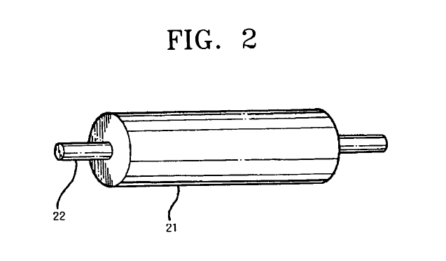

The electroconductive toner supply roller according to present embodiment includes a polyurethane foam member 21 and a core bar 22 as illustrated in FIG. 2. The polyurethane foam 21 has an electroconductive carbon black, a binder resin and a CCA impregnated thereinto or attached thereto. While the polyurethane foam which is less expensive and has a lower hardness than silicone is used in the present invention, the charge property of a toner is tremendously improved compared to conventional polyurethane foam toner supply rollers.

In general, the polyurethane foam is provided with electroconductivity by adding a separate conducting agent when preparing a foam or by impregnating a finished foam with a separate impregnation solution. When adding the separate conducting agent, the cost of the process is low since a separate impregnating process is not required, but the formation of a foam is difficult due to the conducting agent. The impregnation method includes impregnating a polyurethane foam prepared previously with an impregnation solution containing an antistatic agent, an electroconductive polymer, a conducting agent, such as an electroconductive carbon black, and a binder resin in a solvent such as water, alcohol, ether, and drying the impregnated polyurethane foam to provide a polyurethane foam with electroconductivity. While the impregnation method requires a separate impregnation process, it is advantageous in that a foam can be easily formed. In other embodiments, other electroconductive agents (conducting agents) and other solvents can be used.

In the present invention, even though the polyurethane foam is endowed with electroconductivity by the impregnation method, the charge property of a toner can be further improved by adding a CCA to an impregnation solution used in the impregnation process.

The polyurethane foam used in the present invention may be an open cellular or semi-open cellular polyurethane foam.

The electroconductive carbon black used in the present invention has preferably a large mean particle diameter and a large surface area. Non-limitary examples of suitable electroconductive carbon black include acetylene black, such as Ketzen black EC, Ketzen black 300J, Ketzen black 600J, Valkan XC, Valkan CSX and Denka black, and conductive furnace black, and the like.

The amount of the electroconductive carbon black is preferably 1 to 30 parts by weight based on 100 parts by weight of the polyurethane foam. When the amount of the electroconductive carbon black is below the above range, it is difficult to obtain the desired electroconductivity. When the amount exceeds the above range, the carbon black may be separated from the foam or deteriorate physical properties, such as elasticity, of the foam, and thus it is not preferable.

Examples of a suitable binder resin include, but are not limited to, polyacrylic ester resin, acrylic acid-styrene copolymer, polyvinylalcohol, polyacrylamide, polyvinyl chloride resin, urethane resin, vinyl acetate resin, butadiene resin, epoxy resin, alkyd resin, melamine resin, chloroprene resin, etc. These binder resins may be used alone or in a combination of two or more.

The amount of the binder resin is preferably 1 to 30 parts by weight based on 100 parts by weight of the polyurethane foam. When the amount of the binder resin is below the above range, the electroconductive carbon black or CCA may separate from the cell wall of the polyurethane foam due to insufficient adhesion force. When the amount exceeds the above range, the restoring force of the polyurethane foam is reduced.

The CCA used in the present invention is preferably charged oppositely to the toner being used. Thus, the charge controlling agent is negatively charged when the toner is positively charged and the charge controlling agent is positively charged when the toner is negatively charged.

Examples of a positive CCA include, but are not limited to, Nigrosine dyes, such as “Nigrosine Base Ex”, “Oil Black BS”, “Oil Black SO”, “Bontron N-01”, “Bontron N-07” and “Bontron N-11” (all manufactured by Orient Chemical); triphenylmethane-based dyes containing a tertiary amine in their side chains; quaternary ammonium salt compounds, such as “Bontron P-51” (manufactured by Orient Chemical), cetyltrimethylammonium bromide and “Copy Charge PX VP435” (manufactured by Hoechst); polyamine resins, such as “Bontron P-52” (manufactured by Orient Chemical); and imidazole derivatives, although other CCA can be used.

Examples of the negative CCA include, but are not limited to, metal-containing azo dyes, such as “Varifast Black 3804”, “Bontron S-31”, “Bontron S-32”, “Bontron S-34” (all manufactured by Orient Chemical), “T-77” and “Aizenspilon Black TRH” (both manufactured by Hodogaya Chemical); copper phthalocyanine dyes; metal complexes of alkyl derivative of salicylic acid, such as “Bontron E-81”, “Bontron E-82” and “Bontron E-85” (all manufactured by Orient Chemical); quaternary ammonium salts, such as “Copy Charge NX VP434” (manufactured by Hoechst); and nitroimidazole derivatives, although others can be used.

The amount of the CCA is preferably 1 to 30 parts by weight based on 100 parts by weight of the polyurethane foam. When the amount of the CCA is below the above range, it does not affect the charge of the toner. When the amount exceeds the above range, electroconductivity of the roller is reduced.

In another embodiment of the present invention, a method of preparing an electroconductive toner supply roller includes: preparing a polyurethane foam by adding additives including a catalyst, a blowing agent and an antifoaming agent to a compound having at least two active hydrogens and a compound having at least two isocyanate groups, and stirring and mixing the components to expand and cure; impregnating the polyurethane foam with an impregnation solution containing an electroconductive carbon black, a binder resin and a CCA to attach the electroconductive carbon black, the binder resin and the CCA to cell walls of the polyurethane foam; drying the polyurethane foam; inserting a core bar into the polyurethane foam to adhere the polyurethane foam to the core bar; and polishing an outer surface of the polyurethane foam.

The polyurethane foam can be prepared by adding additives including a catalyst, a blowing agent, an antifoaming agent, etc., to a compound having at least two active hydrogens and a compound having at least two isocyanate groups. The resulting reaction mixture is stirred and mixed to expand the reaction mixture to form a foam and to cure the resulting foam.

The compound having at least two active hydrogens may be polyol generally used as a raw material is producing a polyurethane foam. Examples of suitable polyols include polyether polyol, polyester polyol, polyeterester polyol, etc. having hydroxyl groups at their terminal ends, and modified polyols, such as acryl modified polyol and silicone modified polyol, but is not limited thereto.

The compound having at least two isocyanate groups may be polyisocyanate generally used as a raw material for producing polyurethane foams Examples of suitable polyisocyanates include, but are not limited to, toluenediisocyanate (TDI), 4,4-diphenylmethanediisocyanate (MDI), and a mixture of modified products of these polyisocyanates.

The catalyst used in the preparation of the polyurethane foam is selected and the amount thereof is adjusted to improve the blowing properties, reduce the reaction time, improve the air permeability of a foam, and minimize the density difference. Examples of catalysts that satisfy these requirements include, but are not limited to, an organometallic compound containing Sn, Pb, Fe, Ti, or the like and amine-based compounds. Tertiary amines are particularly preferable. The reactivity of the amine-based compound catalyst is dependent on basicity and steric hindrance.

The blowing agent used in the preparation of the polyurethane foam may be a material with a low boiling point, such as water or halo-alkane, for example, trichlorofluoromethane. Water or Freon® is preferable.

The antifoaming agent used in the preparation of the polyurethane foam reduces the surface tension to improve compatibility, makes the size of the generated cells uniform, and adjusts the cell structure of the foam to stabilize the blowing agent. Preferably, the antifoaming agent is a silicone antifoaming agent and is added in an amount of 0.1 to 5 parts by weight based on 100 parts by weight of the compound having at least two active hydrogens. When the amount of the antifoaming agent is below the above range, the desired antifoaming effect is not obtained. When the amount exceeds the above range, physical properties such as compression set are deteriorated.

The resulting polyurethane foam is impregnated with an impregnation solution to attach a material to the surfaces of the foam for providing electroconductivity and a material for improving a charge property to the cell wall of the polyurethane foam.

The impregnation solution further contains a CCA for improving the charge property as well as conventional materials for providing electroconductivity, such as an electroconductive carbon black, and a binder resin. The CCA is the same as described above and is charged oppositely to the toner. Thus, a negative CCA is used when a toner is positively charged and a positive CCA is used when a toner is negatively charged. The amount of the CCA is 1 to 30 parts by weight based on 100 parts by weight of the polyurethane foam.

After impregnating, the polyurethane foam passes through a drying device, such as a forced convection oven, to dry the foam and evaporate the solvent or carrier liquid of the impregnating solution. At this time, the drying temperature is preferably 50 to 300° C. and the drying time is preferably 10 to 60 min.

A core bar composed of metal etc. is inserted into the polyurethane foam and heated in an oven to adhere the polyurethane foam to the core bar. An adhesive or bonding agent can be used. At this time, the heating temperature is preferably 50 to 200° C.

Finally, the outer surface of the polyurethane foam is polished using a polisher to obtain the electroconductive toner supply roller according to an embodiment of the present invention.

In another embodiment of the present invention, an electrophotographic imaging apparatus includes the electroconductive toner supply roller.

Electrophotographic imaging apparatuses employing the electroconductive toner supply roller according to an embodiment of the present invention include, but are not limited to, conventional electrophotographic imaging apparatuses such as a printer including a laser beam or LED print head type printer, a fax machine, a photocopier, and a multifunction device.

The present invention will now be described in greater detail with reference to the following examples. The following examples are for illustrative purposes only, and are not intended to limit the scope of the invention.

Preparation of an Electroconductive Toner Supply Roller (Based on Negatively Charged Toner)

### EXAMPLE 1

100 parts by weight of polyester polyol (GP-3000, Korean Polyol, acid value: 54 mgKOH/g), a mixture of 0.3 part by weight of stannous octoate and 0.2 part by weight of triethyl amine as a catalyst, 4.0 parts by weight of water as a blowing agent, 1.5 parts by weight of silicone antifoaming agent (Witco, L-1002) were mixed to prepare a premix polyol. 105 parts by weight of toluene diisocyanate was added to the premix polyol and then, mixed, stirred, and expanded to prepare a polyurethane foam.

The prepared polyurethane foam was impregnated with an impregnation solution including 100 parts by weight of water, 8 parts by weight of an electroconductive carbon black (Ketzen black 300J, Lyon, Japan), 10 parts by weight of acrylic resin (MX-1845, Mitsubishi Rayon) as a binder resin and 5 parts by weight of a positive CCA N-07 (Orient Chemical), squeezed on a roller and placed in a forced convection oven at 130° C. for 10 min to remove the solvent.

The dried polyurethane foam was cut into a size of 25 mm×25 mm×250 mm using a vertical cutter and its central portion in the longitudinal direction was pierced to make a hole with a diameter of 5.0 mm. A metallic shaft with a diameter of 6.0 mm on which a hot melt sheet was wound was inserted into the hole and heated in a forced convection oven at 120° C. for 30 min to adhere the polyurethane foam to the shaft. Then, the polyurethane foam was polished with a polisher and its both ends were cut to obtain an electroconductive toner supply roller with an outer diameter of 13.4 mm and a length of 220 mm.

### EXAMPLE 2

An electroconductive toner supply roller was prepared in the same manner as in Example 1, except that the amount of the positive CCA N-07 in the impregnation solution was 10 parts by weight based on 100 parts by weight of water.

### EXAMPLE 3

An electroconductive toner supply roller was prepared in the same manner as in Example 1, except that the amount of the positive CCA N-07 in the impregnation solution was 15 parts by weight based on 100 parts by weight of water.

### COMPARATIVE EXAMPLE 1

An electroconductive toner supply roller was prepared in the same manner as in Example 1, except that the positive CCA N-07 was not added to in the impregnation solution.

Components used in the preparation of the polyurethane foam according to Examples 1 through 3 and Comparative Example 1 and their amounts are listed in Table 1.

TABLE 1

| Component | Amount (parts by weight) |
|---|---|
| Polyester polyol | 100 |
| Stannous octoate | 0.3 |
| Triethyl amine | 0.2 |
| Silicone antifoaming agent | 1.5 |
| Water | 4.0 |
| Toluene diisocyanate | 105 |

Components of the impregnation solution used in Examples 1 through 3 and Comparative Example 1 and their amounts are listed in Table 2.

TABLE 2

| | | | | Comparative |
|---|---|---|---|---|
| Component | Example 1 | Example 2 | Example 3 | Example 1 |
| Water | 100 | 100 | 100 | 100 |
| Electroconductive | 8 | 8 | 8 | 8 |
| carbon black | | | | |
| Binder resin | 10 | 10 | 10 | 10 |
| Positive CCA | 5 | 10 | 15 | 0 |

(Unit: parts by weight)

Performance Test

The electroconductive toner supply rollers of Examples 1 through 3 and Comparative Example 1 were fitted on a developing device and 10,000 sheets of paper were printed at 23° C. under a humidity of 55% to evaluate the performance of the electroconductive toner supply rollers. The results are illustrated in Table 3.

TABLE 3

| | | | | Comparative |
|---|---|---|---|---|
| Item | Example 1 | Example 2 | Example 3 | Example 1 |
| L/L | 5.8E+05 | 7.84E+05 | 5.1E+05 | 4.2E+05 |
| environmental | | | | |
| resistance | | | | |
| N/N | 4.60E+05 | 6.84E+05 | 5.7E+05 | 4.1E+05 |
| environmental | | | | |
| resistance | | | | |
| H/H | 4.40E+05 | 6.14E+05 | 4.1E+05 | 3.2E+05 |
| environmental | | | | |
| resistance | | | | |
| Hardness | 64 | 65 | 67 | 64 |
| (Shore F) | | | | |
| Density (kg/m³) | 80 | 80 | 80 | 80 |
| The number of | 82 | 82 | 82 | 82 |
| cell (PPI, the | | | | |
| number of | | | | |
| cell/25 mm) | | | | |
| Compression | 8 | 9 | 10 | 9 |
| set (%) | | | | |

Evaluation Method

1) Measurement of resistance: The electroconductor toner supply roller to be evaluated was fitted on JIG and a conductor bar of 400 g was placed on the roller. Then, a DC voltage of −100 V was applied to the roller shaft and a current was measured while rotating the roller shaft at a constant speed (30 rpm). The measured current was converted into resistance using the following equation:
Resistance (R)=Voltage (V)/Current (I)

The L/L environment is the temperature of 10° C. and the humidity of 20%, the N/N environment is the temperature of 23° C. and the humidity of 55% and the H/H environment is the temperature of 32° C. and the humidity of 80%.

2) Density: A foam of 300×300×50 mm was weighed and its density was obtained by dividing the weight (kg) by the volume (m³).

3) Hardness: The hardness of a 20 mm thick foam was measured using an ASKER F type hardness tester.

4) The number of cell: An optical microscopic photograph (×40 to 70) of a foam was taken and the number of cell was determined according to JIS K6402.

5) Compression set: A sample was compressed to 50% and let alone at 70° C. for 22 hours, and then the thickness of the sample was measured (JIS K6382).
Compression set (%)=(thickness of sample before test−thickness of sample after test)/thickness of sample before test

Image Test

Electrophotographic imaging apparatuses using electroconductive toner supply roller according to Examples 1 through 3 and Comparative Example 1 were let alone under the N/N environment for 8 hours and then 10,000 sheets of paper were printed using them. Image blurring, background, solid density and sweeping mark were investigated to evaluate the image.

The image evaluation results are illustrated in Table 4.

TABLE 4

| | | | | Comparative |
|---|---|---|---|---|
| Item | Example 1 | Example 2 | Example 3 | Example 1 |
| Image blurring | Δ | ◯ | ◯ | Δ |
| Background | X | Δ | Δ | X |
| Solid density | ◯ | ◯ | Δ | Δ |
| Sweeping mark | Δ | Δ | ◯ | Δ |

Evaluation basis
X: poor,
Δ: allowable,
◯: good

As can be seen from the results of Table 3, the electroconductive toner supply rollers according to Examples 1 through 3 have good physical properties in environmental resistance, density, hardness, the number of cell and compression set. Also, as can be seen from the results of Table 4, when printing an image using the electroconductive toner supply rollers according to Examples 1 through 3, superior evaluation results in image blurring, background, solid density and sweeping mark can be obtained compared to when using the electroconductive toner supply roller according to Comparative Example 1.

According to the present invention, there are provided an electroconductive toner supply roller which can minimize toner stress due to its low hardness, be prepared with low costs and prevent formation of a poor image due to an insufficient charge property of the toner, and minimize toner stress. The invention also provides a method of preparing the electroconductive toner supply roller, and an electrophotographic imaging apparatus including the electroconductive toner supply roller.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An electroconductive toner supply roller comprising a polyurethane foam member and a core bar, wherein the polyurethane foam member includes an electroconductive carbon black, a binder resin and a charge controlling agent.

2. The electroconductive toner supply roller of claim 1, wherein said electroconductive carbon black, binder resin and charge control agent are impregnated into or attached to surfaces of said foam binder.

3. The electroconductive toner supply roller of claim 1, wherein the charge controlling agent is charged oppositely to a toner.

4. The electroconductive toner supply roller of claim 1, comprising 1 to 30 parts by weight of the electroconductive carbon black, 1 to 30 parts by weight of the binder resin, and 1 to 30 parts by weight of the charge controlling agent, based on 100 parts by weight of the polyurethane foam.

5. A method of preparing an electroconductive toner supply roller, comprising:
preparing a polyurethane foam member by adding additives including a catalyst, a blowing agent and an antifoaming agent to a compound having at least two active hydrogens and a compound having at least two isocyanate groups to form a reaction mixture, stirring and mixing said reaction mixture to expand and cure said reaction mixture to form the polyurethane foam;
impregnating the polyurethane foam member with an impregnation solution containing an electroconductive carbon black, a binder resin and a charge controlling agent to attach the electroconductive carbon black, the binder resin and the charge controlling agent to cell walls of the polyurethane foam member;
drying the polyurethane foam member;
inserting a core bar into the polyurethane foam member and adhering the polyurethane foam member to the core bar; and
polishing an outer surface of the polyurethane foam member.

6. The method of claim 5, wherein said resulting polyurethane foam member of said electroconductive toner supply roller comprises about 1 to about 30 parts by weight of said electroconductive carbon black based on 100 parts by weight of said polyurethane foam member.

7. The method of claim 5, wherein said resulting polyurethane foam member of said electroconductive toner supply roller comprises about 1 to about 30 parts by weight of said binder resin based on 100 parts by weight of said polyurethane foam member.

8. The method of claim 5, wherein said resulting polyurethane foam member of said electroconductive toner supply roller comprises about 1 to about 30 parts by weight of said charge controlling agent based on 100 parts by weight of said polyurethane foam member.

9. An electrophotographic imaging apparatus comprising the electroconductive toner supply roller of claim 1.

10. A method of producing an electroconductive toner supply roller for use in an electrophotographic imaging apparatus, said method comprising:
impregnating a polyurethane foam member with an electroconductive carbon black, a binder resin and a charge controlling agent, and
attaching the polyurethane foam member to a core bar to form the electroconductive toner supply roller.

11. The method of claim 10, wherein said polyurethane foam member is impregnated with a solution or dispersion of said electroconductive carbon black, binder resin and charge controlling agent.

12. The method of claim 11, wherein said polyurethane foam member is dried after impregnating with said solution or dispersion.

13. The method of claim 10, further comprising polishing an outer surface of said polyurethane foam member.

14. The method of claim 10, wherein said polyurethane member of said electroconducting toner supply roller is impregnated with a solution or dispersion to provide about 1 to 30 parts by weight of said electroconductive carbon black, about 1 to 30 parts by weight of said binder resin, and about 1 to 30 parts by weight of the charge control agent based on 100 parts by weight of the polyurethane foam member.
